(19) United States
(12) Patent Application Publication
(10) Pub. No.: US 2017/0362989 A1
(43) Pub. Date: Dec. 21, 2017

(54) NITROGEN OXIDE PURIFICATION SYSTEM AND CONTROL METHOD OF THE SAME

(71) Applicants: HYUNDAI MOTOR COMPANY, Seoul (KR); KIA MOTORS CORPORATION, Seoul (KR)

(72) Inventor: Jun Sung PARK, Yongin-si (KR)

(21) Appl. No.: 15/691,226

(22) Filed: Aug. 30, 2017

Related U.S. Application Data
(62) Division of application No. 14/835,565, filed on Aug. 25, 2015.

(30) Foreign Application Priority Data
Dec. 1, 2014 (KR) 10-2014-0169905

(51) Int. Cl. F01N 9/00; F01N 3/20; F01N 13/00; F01N 3/08

(52) U.S. Cl. CPC F01N 9/00; F01N 3/0814; F01N 3/0842; F01N 3/2066; F01N 13/0093; F01N 2430/06; F01N 2900/08; F01N 2900/10; Y02T 10/24; Y02T 10/47; F01N 2610/03

(57) ABSTRACT

A nitrogen oxide purification system includes an exhaust line exhausting exhaust gas from a combustion chamber. A first nitrogen oxide purification device is mounted at an upstream side of the exhaust line to primarily purify nitrogen oxides (NOx) included in the exhaust gas, and a second nitrogen oxide purification device is mounted to a downstream side of the first nitrogen oxide purification device to secondarily purify the NOx. A second injector is disposed between the first nitrogen oxide purification device and the first injector to additionally inject fuel for controlling an air/fuel ratio of the exhaust gas.

### CROSS-REFERENCE TO RELATED APPLICATION

This application is a divisional patent application of U.S. patent application Ser. No. 14/835,565, filed on Aug. 25, 2015 which claims the benefit of priority to Korean Patent Application No. 10-2014-0169905 filed in the Korean Intellectual Property Office on Dec. 1, 2014, the entire contents of which are incorporated herein by reference.

### TECHNICAL FIELD

The present disclosure relates to a nitrogen oxide purification system for removing nitrogen oxides (NOx) and a control method of the same, which are noxious substances included in exhaust gas, by varying an air/fuel ratio depending on a driving condition of an engine or vehicle, and a control method of the same.

### BACKGROUND

Due to recent fortified emission regulations, a complex exhaust gas purification system combining an oxidation catalyst, a particulate matter filter device, a nitrogen oxide purification catalyst (LNT: lean NOx trap, or SCR: selective catalytic reduction), and so on has been used to limit pollutant emission.

Particularly, in the EURO emission regulations, a world-harmonized light vehicles test cycle (WLTC) mode, which represents an actual driving condition, has been applied instead of a new European driving cycle (NEDC) mode.

Due to the fortified emission regulations, an additional NOx reducing apparatus is required since a post-processing system, which comprises a combination of an oxidation catalyst and a particulate matter filter device, exhausts a large amount of NOx in a high load driving condition.

When a vehicle is driven in the high load driving condition, the amount of NOx increases and the temperature of exhaust gas passing through a nitrogen oxide purification catalyst also increases, and as a result, a purification rate of NOx is significantly deteriorated.

Further, since the NOx increased in the high load driving condition cannot be purified with the combination of the oxidation catalyst and the particulate matter filter device, and a purification rate may be significantly deteriorated as a temperature of the LNT increases to 450° C. or more in the high load driving condition when the LNT and the particulate matter filter device are used.

In addition, in a low load driving condition, it is difficult to enrich an air/fuel ratio of exhaust gas, and thus purification efficiency of NOx may be deteriorated.

The above information disclosed in this Background section is only for enhancement of understanding of the background of the invention, and therefore, it may contain information that does not form the prior art that is already known in this country to a person of ordinary skill in the art.

### SUMMARY

The present disclosure has been made in an effort to provide a nitrogen oxide purification system and a control method thereof having advantages of separating a driving condition of an engine or a vehicle to a normal or high load condition and a low load condition, and stably or effectively purifying NOx in a normal or high load condition and a low load condition by differently applying air/fuel ratio of exhaust gas depending on a load condition of the engine or a vehicle in a case of purifying the NOx using a nitrogen oxide purification catalyst.

A nitrogen oxide purification system according to an exemplary embodiment of the present inventive concept includes an exhaust line exhausting exhaust gas combusted in a combustion chamber. A first nitrogen oxide purification device is mounted at an upstream side of the exhaust line to primarily purify nitrogen oxides (NOx) included in the exhaust gas. A second nitrogen oxide purification device is mounted at a downstream side of the first nitrogen oxide purification device to secondarily purify NOx included in the exhaust gas. A second injector is disposed between the first nitrogen oxide purification device and the first injector to additionally inject fuel for controlling an air/fuel ratio of the exhaust gas. The first nitrogen oxide purification device and the second nitrogen oxide purification device may enrich the air/fuel ratio of the exhaust gas which passes through the exhaust line in a nitrogen oxide purification mode when a driving condition of an engine or a vehicle is in a normal or high load driving section, and vary the air/fuel ratio of the exhaust gas which passes through the exhaust line for a predetermined period when a driving condition of the engine or the vehicle is in a low load driving section.

The first nitrogen oxide purification device may include a noble metal, an alkali metal, an alkaline-earth metal, or a rare earth metal.

The second nitrogen oxide purification device may include a metal oxide or a zeolite.

The driving condition of the vehicle may include a normal load, a high load, and a low load driving sections depending on any combination of a rotational speed, an output torque, or a fuel amount of an engine.

The predetermined period for varying the air/fuel ratio may be 0.1-10 seconds and a duty cycle may be 0-95% in the nitrogen oxide purification mode under the low load driving section. The predetermined period and duty cycle may vary depending on the driving condition.

In the nitrogen oxide purification mode under the low load driving section, the air/fuel ratio varies depending on the driving condition.

The system may further include an oxygen sensor mounted at the exhaust line to detect a concentration of oxygen included in the exhaust gas. A NOx sensor is mounted at the exhaust line to detect a concentration of NOx included in the exhaust gas.

The system may further include a controller configured to receive and process a detection signal of the oxygen sensor and a detection signal of the NOx sensor. The controller may further control the first injector or the second injector to control the air/fuel ratio such that NOx are adsorbed and purified in the first nitrogen oxide purification device and the second nitrogen oxide purification device.

A control method of a nitrogen oxide purification system for removing NOx according to another exemplary embodiment of the present inventive concept includes: determining, by a controller, a nitrogen oxide purification mode of a first nitrogen oxide purification device and a second nitrogen oxide purification device; determining a driving condition of an engine; and completing the nitrogen oxide purification mode.

### BRIEF DESCRIPTION OF THE DRAWINGS

FIG. 1 is a schematic diagram of a nitrogen oxide purification system according to an exemplary embodiment of the present inventive concept.

FIG. 2 is a flowchart showing control flow of a nitrogen oxide purification system according to an exemplary embodiment of the present inventive concept.

FIG. 3 is a table showing material of a nitrogen oxide purification device used for a nitrogen oxide purification system according to an exemplary embodiment of the present inventive concept.

FIG. 4 is a graph showing a driving condition of a nitrogen oxide purification system according to an exemplary embodiment of the present inventive concept.

### DETAILED DESCRIPTION OF THE EMBODIMENTS

Exemplary embodiments of the present inventive concept will hereinafter be described in detail with reference to the accompanying drawings.

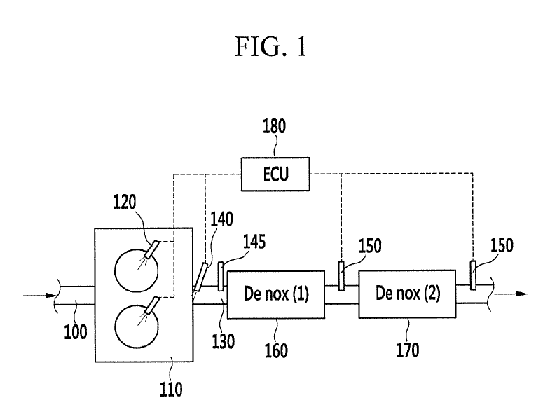

FIG. 1 is a schematic diagram of a nitrogen oxide purification system according to an exemplary embodiment of the present inventive concept.

Referring to FIG. 1, a nitrogen oxide purification system may include an intake line 100, an engine 110, a first injector 120, an exhaust line 130, a second injector 140, an oxygen sensor 145, a first nitrogen oxide purification device 160, a nitrogen oxides (NOx) sensor 150, a second nitrogen oxide purification device 170, and a controller 180.

The intake line 100 supplies outside air into a combustion chamber, and the first injector 120 of the engine 110 injects a fuel into the combustion chamber to generate combustion of the air and the fuel in the combustion chamber. This combustion gas is exhausted out through the exhaust line 130.

The second injector 140 is mounted at the exhaust line 130 and injects fuel or ethanol from a fuel tank, e.g., a fuel tank connected with the first injector 120 or an extra fuel tank, (not shown) to an upstream side of the exhaust line 130.

The oxygen sensor 145 detects oxygen concentration of the exhaust gas flowing into the first nitrogen oxide purification device 160 via an inlet of the exhaust line 130 and generates a signal. The controller 180 detects an air/fuel ratio of the exhaust gas depending on the signal generated from the oxygen sensor 145 and controls the air/fuel ratio of the exhaust gas.

The NOx sensor 150 is mounted to a downstream side of the first nitrogen oxide purification device 160 or the second nitrogen oxide purification device 170 so as to detect concentration of the NOx and to transmit the detected information of the nitrogen oxides concentration to the controller 180.

The controller 180 may have at least one microprocessor which is operated by a predetermined program, and the predetermined program may include a series of commands for performing a method according to an exemplary embodiment of the present inventive concept to be described later.

In the present disclosure, a nitrogen oxide purification method effectively NOx which is a noxious gas being exhausted from the engine 110.

That is, the air/fuel ratio of the exhaust gas flowing into the first nitrogen oxide purification device 160 is controlled to be an enriched condition (A<1) in a normal or high load driving condition.

Further, the air/fuel ratio of the exhaust gas flowing into the first nitrogen oxide purification device 160 varies for a predetermined period in a low load driving condition. Herein, controlling the air/fuel ratio to vary for the predetermined period means controlling the air/fuel ratio to vary while periodically repeating a current air/fuel ratio (λ_{current}) and a varied air/fuel ratio (λ_{current}−Δλ).

As described above, the nitrogen oxide is purified in the first nitrogen oxide purification device 160 by controlling the air/fuel ratio of the exhaust gas which flows into the first nitrogen oxide purification device 160 to be enriched in the normal or high load driving condition, and a reducing agent is generated in the first nitrogen oxide purification device 160 at this step.

The second nitrogen oxide purification device 170 additionally purifies the NOx included in the exhaust gas using the reducing agent generated from the first nitrogen oxide purification device 160.

Further, the second nitrogen oxide purification device 170 varies the air/fuel ratio of the exhaust gas flowing into the first nitrogen oxide purification device 160 for the predetermined period in the low load driving condition.

The first nitrogen oxide purification device 160 occludes or adsorbs NOx in a lean state of the exhaust gas, and desorbs and purifies the adsorbed nitrogen oxides in an enriched state of the exhaust gas.

In addition, in the normal or high load driving condition, the first nitrogen oxide purification device 160 purifies the NOx and simultaneously generates the reducing agent. The second nitrogen oxide purification device 170 adsorbs the reducing agent generated from the first nitrogen oxide purification device 160 and reacts the adsorbed reducing agent with the supplied nitrogen oxide so as to purify the NOx.

When the first nitrogen oxide purification device 160 is provided and the second nitrogen oxide purification device 170 is not provided, NOx, which is not purified in the first nitrogen oxide purification device 160, and the reducing agent may be released into the atmosphere in the normal or high load condition.

According to the present disclosure, NOx may be additionally purified and the reducing agent released into the atmosphere may be reduced.

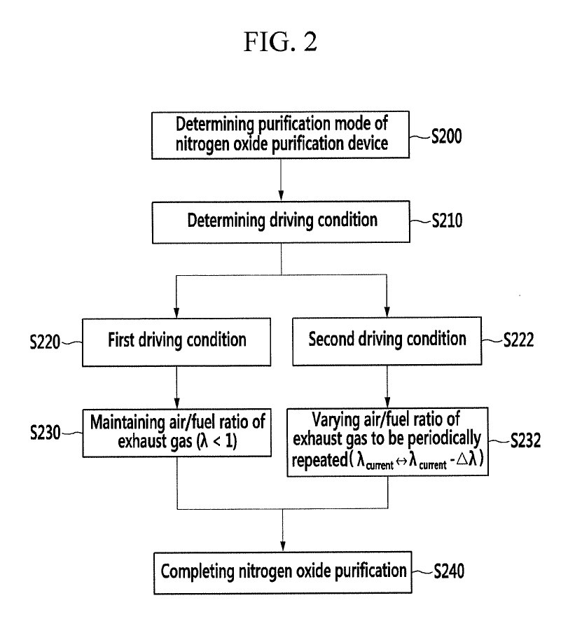

FIG. 2 is a flowchart showing control flow of a nitrogen oxide purification system according to an exemplary embodiment of the present inventive concept.

Referring to FIG. 2, a purification mode of a nitrogen oxide purification device is determined at step S200. The purification mode is performed by the NOx sensor 150, and is performed depending on a driving condition.

A driving condition of the engine 110 is determined at step S210. Herein, a driving condition may include low load, normal load, and high load driving conditions.

In the present disclosure, the driving condition is determined depending on any combination of a rotational speed, an output torque, or a fuel amount of the engine 110, and the driving condition is the normal or high load driving condition when the determining value is the same as or more than a predetermined value at BMEP 3-10 bar, and is a low load driving condition when the determining value is less than the predetermined value with at BMEP 3-10 bar. Herein, partial sections may overlap.

Step S230 is performed if the driving condition is determined to be a first driving condition, which is the normal or high load driving condition, at step S220, and step S232 is performed if the driving condition is determined to be a second driving condition, which is the low load driving condition, at step S222.

At step S230, the controller 180 controls the first injector 120, the second injector 140, or an intake system so as to maintain the air/fuel ratio of the exhaust gas flowing into the first nitrogen oxide purification device 160 to be enriched (λ<1).

On the other hand, at step S232, the controller 180 controls the first injector 120, the second injector 140, or the intake system so as to vary the air/fuel ratio of the exhaust gas flowing into the first nitrogen oxide purification device 160 to periodically repeat the current air/fuel ratio (λ_{current}) and the varied air/fuel ratio (λ_{current}−Δλ). The purification mode of nitrogen oxide is completed at step S240.

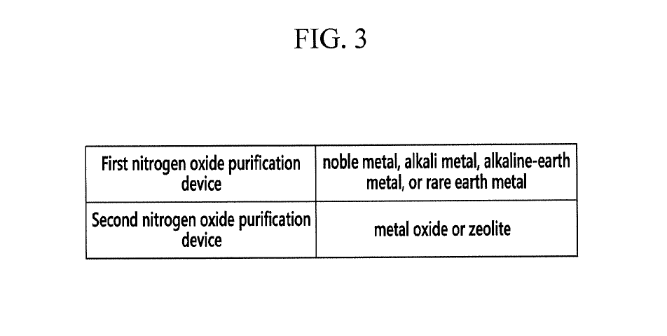

FIG. 3 is a table showing material of a nitrogen oxide purification device being used in a nitrogen oxide purification system according to an exemplary embodiment of the present inventive concept.

Referring to FIG. 3, the first nitrogen oxide purification device 160 may include at least one of a noble metal, an alkali metal, an alkaline-earth metal, and a rare earth metal, and the second nitrogen oxide purification device 170 may include at least one of a metal oxide and a zeolite.

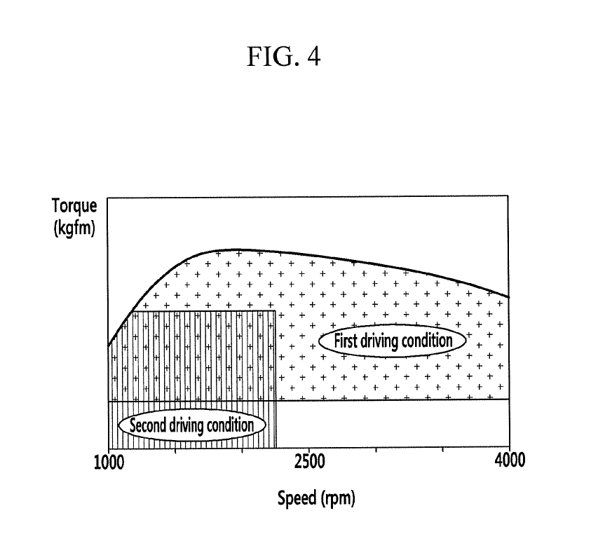

FIG. 4 is a graph showing a driving condition of a nitrogen oxide purification system according to an exemplary embodiment of the present inventive concept.

Referring to FIG. 4, a horizontal axis represents rotational speed of the engine 110, a vertical axis represents output torque of the engine 110, the first driving condition includes sections where the rotational speed and the output torque are relatively high, and the second driving condition includes sections where the rotational speed and the output torque are relatively low. The first driving condition and the second driving condition are partially overlapped with each other.

In the present disclosure, the first injector 120 or the second injector 140 inject a fuel or a reducing agent for varying the air/fuel ratio of the second injector 140 in a nitrogen oxide purification mode of the low load driving section for 0.1-10 seconds. A duty cycle of the second injector 140 used in a nitrogen oxide purification mode of the low load driving section may be within 0-95%. The period and the duty cycle may vary depending on an engine driving condition.

In addition, the nitrogen oxide purification mode starts according to one of the amount of nitrogen oxides occluded/adsorbed in the first nitrogen oxide purification device 160 or the driving condition, and the nitrogen oxide purification is performed within 5-80% of the maximum occluded/adsorbed amount of nitrogen oxides in the first nitrogen oxide purification device 160.

Further, the present disclosure, the air/fuel ratio of the exhaust gas passing through the exhaust line 130 may be controlled by the amount and time of the reducing agent injected from the first injector 120 or the second injector 140. Furthermore, the air/fuel ratio of the exhaust gas passing through the exhaust line 130 may be controlled by the amount of the recirculation exhaust gas recirculated from the exhaust line 130 to the intake line 100, an angle of a turbine vane of a turbocharger, and opening of a throttle valve mounted to the intake line 100.

According to the present disclosure, the second nitrogen oxide purification device is mounted to a downstream side of the first nitrogen oxide purification device, the air/fuel ratio of the exhaust gas is enriched in the normal or high load condition so as to purify nitrogen oxide in the first nitrogen oxide purification device, and the nitrogen oxide are purified again by the reducing agent generated therein in the second nitrogen oxide purification device such that purification performance of nitrogen oxide may be improved and fuel consumption may be better.

In addition, in the low load condition, purification performance of the nitrogen oxide may be improved in all engine or vehicle driving conditions by periodically varying the air/fuel ratio of the exhaust gas.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A control method of a nitrogen oxide purification system for removing NOx, the method comprising:
determining, by a controller, a nitrogen oxide purification mode of a first nitrogen oxide purification device and a second nitrogen oxide purification device;
determining, by the controller, a driving condition of an engine; and
completing, by the controller, the nitrogen oxide purification mode.

2. The control method of claim 1, wherein the driving condition includes a low load driving condition, a normal load driving condition, and a high load driving condition.

3. The control method of claim 1, wherein the driving condition is determined depending on any combination of a rotational speed, an output torque, or a fuel amount of the engine.

4. The control method of claim 1, further comprising, before the step of completing:
maintaining an air/fuel ratio of exhaust gas which flows into the first nitrogen oxide purification device when it is determined that the driving condition is a normal or high load driving condition.

5. The control method of claim 1, further comprising, before the step of completing:
varying an air/fuel ratio of exhaust gas which flows into the first nitrogen oxide purification device when it is determined that the driving condition is a low load driving condition.

6. The control method of claim 1, wherein the nitrogen oxide purification system comprises:
a first injector injecting fuel into a combustion chamber;
an exhaust line exhausting the exhaust gas combusted in the combustion chamber;
the first nitrogen oxide purification device mounted at an upstream side of the exhaust line to primarily purify nitrogen oxides (NOx) included in the exhaust gas;
the second nitrogen oxide purification device mounted at a downstream side of the first nitrogen oxide purification device to secondarily purify the NOx included in the exhaust gas; and
a second injector disposed between the first nitrogen oxide purification device and the first injector to additionally inject fuel for controlling an air/fuel ratio of the exhaust gas.
